(19) United States
(12) Patent Application Publication
(10) Pub. No.: US 2002/0052785 A1
(43) Pub. Date: May 2, 2002

(54) Computerized advertising method and system

(76) Inventor: Samuel Sergio Tenenbaum, Punta Del Este (UY)

Correspondence Address: DARBY & DARBY P.C., 805 Third Avenue, New York, NY, 10022, US

(21) Appl. No.: 09/922,232

(22) Filed: Aug. 3, 2001

Related U.S. Application Data
(63) Continuation of application No. PCT/US00/30987, filed on Sep. 13, 2000.
(60) Provisional application No. 60/164,985, filed on Nov. 11, 1999.

(51) Int. Cl. G06F 17/60

(52) U.S. Cl. 705/14

(57) ABSTRACT

Advertising is presented on a computer screen in the form of an animated multimedia character that will be referred to here as a “Shoshkele.” The Shoshkele appears on the screen in an intrusive way at times which, to the user, are unpredictable, and it is entirely out of his control. The Shoshkele can move over the entire screen and is in the top layer of the display of the browser program, so it is not covered up by any window or object. It can also provide sound, including speech, music and sound effects. The sporadic appearance of the Shoshkele and its entertainment value draw the attention of the user. The present advertising concept and Shoshkeles can be realized with existing technology.

### FIELD OF THE INVENTION

The present invention relates generally to advertising in new media, such as the Internet and in software programs and, more particularly, relates to method and a system for achieving such advertising.

### BACKGROUND OF THE INVENTION

Users of the Internet are aware of the growing amount of advertising material appearing there. Typically, it is in the form of banners which deliver the advertiser's message. However, the more advertising that appears in this form, the less effective it appears to be. That is because this form of advertising suffers from a number shortcomings. For one thing, the banners are always present and all too similar, so they offer very little interest to the user, and it becomes too easy for a user to ignore them. For another, the user can simple scroll his screen and make them disappear. Banners also take up valuable screen space and cause the screen to be cluttered and overcrowded. There is therefore a need for a much more effective form of advertising with more of an entertainment content.

In accordance with the present invention, advertising is presented on a computer screen in the form of an animated multimedia character that will be referred to here as a “Shoshkele.” The Shoshkele appears on the screen in an intrusive way at times which, to the user, are unpredictable, and it is entirely out of his control. The Shoshkele can move over the entire screen and is in the top layer of an application program display, preferably a browser window, in an operating system such as Windows, so it is not covered up by any window or object. It can also provide sound, including speech, music and sound effects. The sporadic appearance of the Shoshkele and its entertainment value draw the attention of the user. The present advertising concept and Shoshkeles can be realized with existing technology.

Shoshkeles can be distributed in a variety of computerized media, such as wrapware (commercial software), freeware (free software) and shareware (partially free software) and other software categories, Internet websites, as well as any screen-surfaces, whether existing or to be developed (windows, tables, walls, windscreens, garments, etc.).

A cookie identifies the client and a script sorts out different Shoshkeles from a database, based upon the client's Shoshkele viewing history parameters. The JavaScript script is embedded in a page that executes a FLASH object or animated GIF and the sound. The animation and sound will be synchronized. The sound format could be WAV, MP3, Quicktime, Real Audio, AVI, proprietary, etc., with our without a plug-in. A Shoshkele tag is embedded into each web page from a content provider. When the Shoshkele tag in a web page is executed, the user is connected to a Shoshkele server, and a cookie conveys his/her identity and Shoshkele history viewing information. The Shoshkewle server selects the proper Shoskele, based on the client's viewing history and the technology available in his computer. The Shoshkele Web model is also applicable to all wireless technologies and operational systems for electrical appliances (PCS, Paln, OS, Windows CE, Aperios Sony, General Magic, Set Top Boxes, etc.).

The Shoshkeles are marketed in conjunction with Publicity Agencies, Press Agencies, Internet Service Providers (ISP's), Content Providers, etc. In Web Platforms, the pricing can be determined on a CPM basis (Cost per Thousand Impressions) and according to the traffic in the web page in which the Shoshkele appears, or by actual clickthroughs to the sponsor site, or on a per second, per user basis, or upon a combination of these.

The users will receive various forms of incentive, such as: Surprise prizes for users who choose to clickthrough at once (“click it or lose it”), or to the user number “n” who clicks through, etc. To enhance interest, the Shoshkeles can be programmed in such a way as to tell a story.

Certain software may be sponsored by more than one sponsor. The Shoshkeles program can be executed in either Windows, Macintosh, or in the application in question. The Shoshkeles appear from time to time, for instance, when opening up a menu, instead of the commands.

In other Non-Web Platforms, such as paid software, the Shoshkeles could be less intrusive, taking into consideration that the user actually paid for the software. Thus, in this case, the Shoshkeles will enhance productivity, rather than interfere with it. For instance, an Office Assistant featuring a T-shirt with the advertised product).

In all cases the Shoshkeles could resemble celebrities (voice and/or image) to enhance the brand awareness of the advertised product.

### BRIEF DESCRIPTION OF THE DRAWINGS

The foregoing brief description, as well as further objects features and advantages of the present invention will be understood more completely from the following detailed description of presently preferred embodiments, with reference being had to the accompanying drawings, in which:

FIG. 1 is a functional block diagram illustrating a system utilizing the present invention;

FIG. 2 is a flowchart illustrating the operation of user monitor 10 in FIG. 1;

FIG. 3 is a flowchart illustrating the process for determining which is to be used to produce a Shoshkele on a user's computer;

FIG. 4 is a block diagram illustrating the business model for carrying on computerized advertising in accordance with the present invention; and

FIG. 5 is a block diagram illustrating the business model for carrying on a computerized greeting service in accordance with the present invention.

### DETAILED DESCRIPTION OF THE PREFERRED EMBODIMENTS

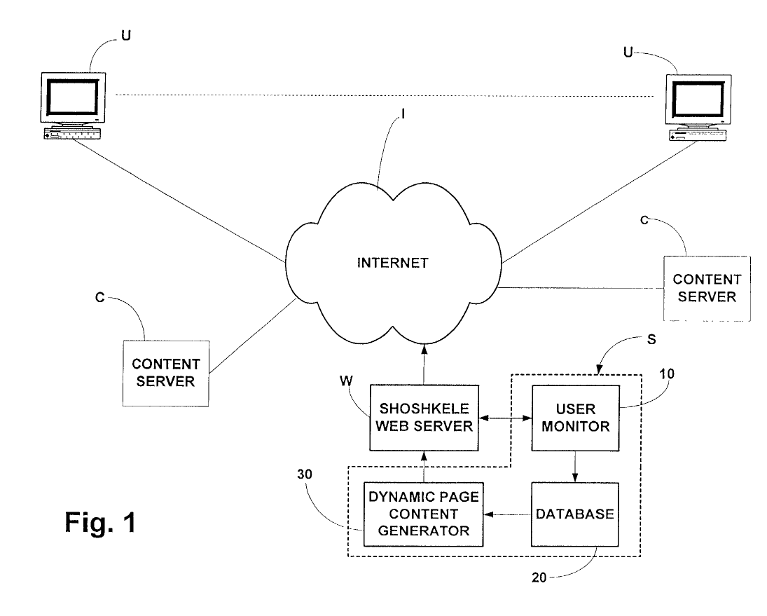

Turning now to the details of the drawings, FIG. 1 is a functional block diagram illustrating a system utilizing the present invention. A plurality of users U communicate as clients with one or more content servers C through the internet I, in order to receive multimedia content from a content provider. Within a web page received from a server C, a user will encounter a tag, which will transfer his computer to the Shoshkele web server W. Server W cooperates with or includes the system S embodying the present invention in order to perform the method thereof The system comprises a website user monitor 10, a database 20 and a dynamic page content generator 30.

In operation, the user monitor 10 monitors access by all users to the webserver W and identifies the users through the use of cookies. The identity of the user is provided to database 20, which provides information about the user to the dynamic page content generator 30, which produces a Shoshkele to be inserted the web page being viewed by the user. Monitor 10, database 20 and dynamic page content generator 30 could, although they need not necessarily, be realized as separate software programs running on the same computer as the webserver W.

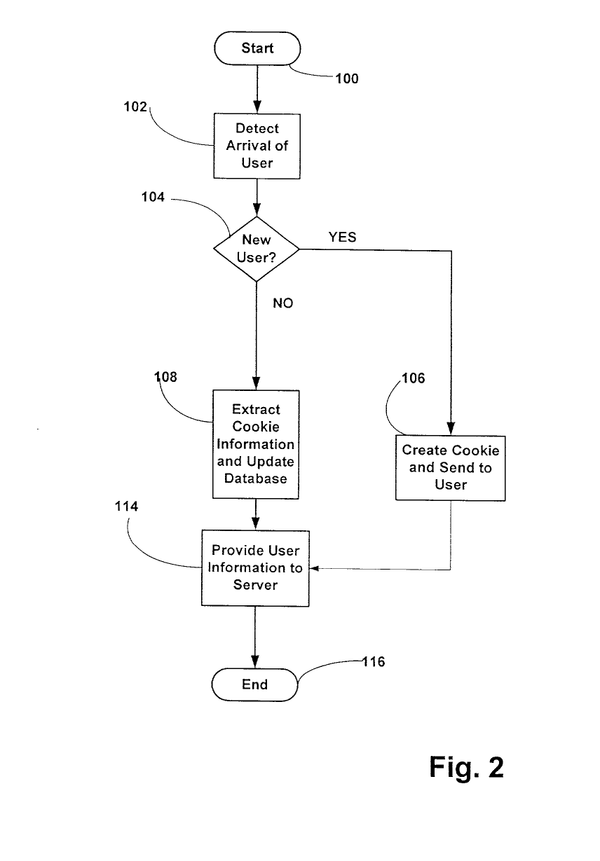

FIG. 2 is a flowchart illustrating the operation of user monitor 10. Operation starts at block 100, with the arrival of the user being detected at block 102. At this point server W preferably sends a JavaScript script to the user, as a result of which his computer is interrogated to locate a Shoshkele cookie to determine what technology is present (e.g. the brand and version of his browser software and what plug-ins are installed). Next, it is determined at block 104 whether this is a new user (this would be the case, for example, if he had no Shoshkele cookie) and, if so, his computer is sent as Shoshkele cookie at block 106. This cookie contains identifying information for the user and a record of recent Shoshkele accesses by this user. Thus, before the cookie is sent to the user, it would be updated with information about the Shoshkele being prepared for him. Operation terminates at block 116.

If it is determined at block 104 that this is not a new user, Shoshkele cookie information is extracted from the user at block 108 and used to update database 20. At this point, the database would receive full information stored in the cookie related to Shoshkele accesses by the user. At block 114, user information is provided to the server for the preparation of a Shoshkele, upon which operation terminates at block 116. It should be appreciated that prior to such termination information about the user's access to the Shoshkele would be recorded in his cookie.

The preferred animation software for producing a Shoshkele in a web page is Flash by Macromedia. The Shoshkele animation is created in Flash, and the accompanying audio is encoded in MP3 by the Flash program itself from a web original. Then, a public domain JavaScript script is modified to allow it to support and contain any object including animations of different sizes an shapes and to position the Shoshkele anywhere on the screen. That JavaScript script inserts a Flash object on the top layer of the display of the browser window, making it unscrollable. Another JavaScript script is also written and inserted which functions to communicate with the Flash object to time its execution (e.g. play twenty seconds after the page is downloaded). This system will only work without intruding on the background page in Internet Explorer versions 4.0 and above, and it must have the Flash plug-in.

As an alternate, technology for producing the Shoshkele, an animated GIF is acquired by a JavaScript script as in the preceding example, but instead of containing a Flash object it contains a GIF object. In addition a WAV object is acquired by the HTML code. To get the desired time line for the Shoshkele, a function of the Dreameweaver program called ‘Time line’ is used. Synchronization between GIF and the WAV objects (animation and audio) is achieved through that embedding. All the surrounding area of the GIF will stay transparent, revealing what lies in the layer below. Thus, the viewer sees a character and not a rectangle or rectangular window. This will work with both Internet Explorer and Netscape 4.0 and above and other browsers that have layer technology in them.

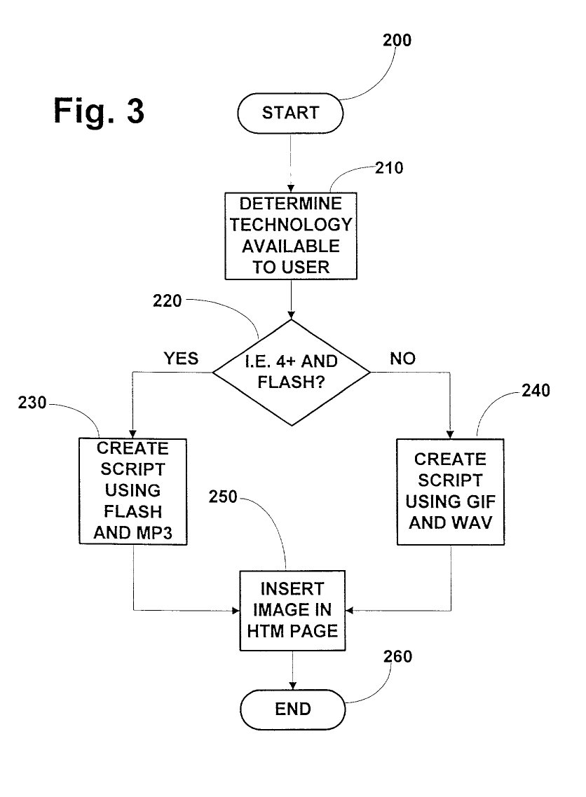

The HTML page provided by server W can access both technologies and will play the first option if all the requisite technology is present in the user's computer or the second one, if they are not. The user will never notice that a choice was made. FIG. 3 is a flowchart illustrating the process determining which script will be used. The process starts at block 200, with a determination being made at block 210 regarding what technology is available in the user's computer to receive the Shoshkele. If the computer has Internet Explorer 4.0 or higher and Flash, a script is created at block 11 which produces coordinated Flash image containing MP3 or other sound files. If the computer lacks this technology, a script is produced at block 240 which produces an animated GIF file and a synchinized WAV file, as discussed above. At block 250, the appropriate code is generated to produce the Shoshkele in the HTML page provided to the user from the server. The process then terminates at block 260.

The original JavaScript script used as a basis for writing the JavaScript scripts that drive the Shoshkeles is in the public domain, but all modifications were done for the purpose of the present invention and are innovative in their result, i.e. they permit any animation to be played, with different sizes, anywhere on the screen, therefore achieving an unique result: the Shoshkele.

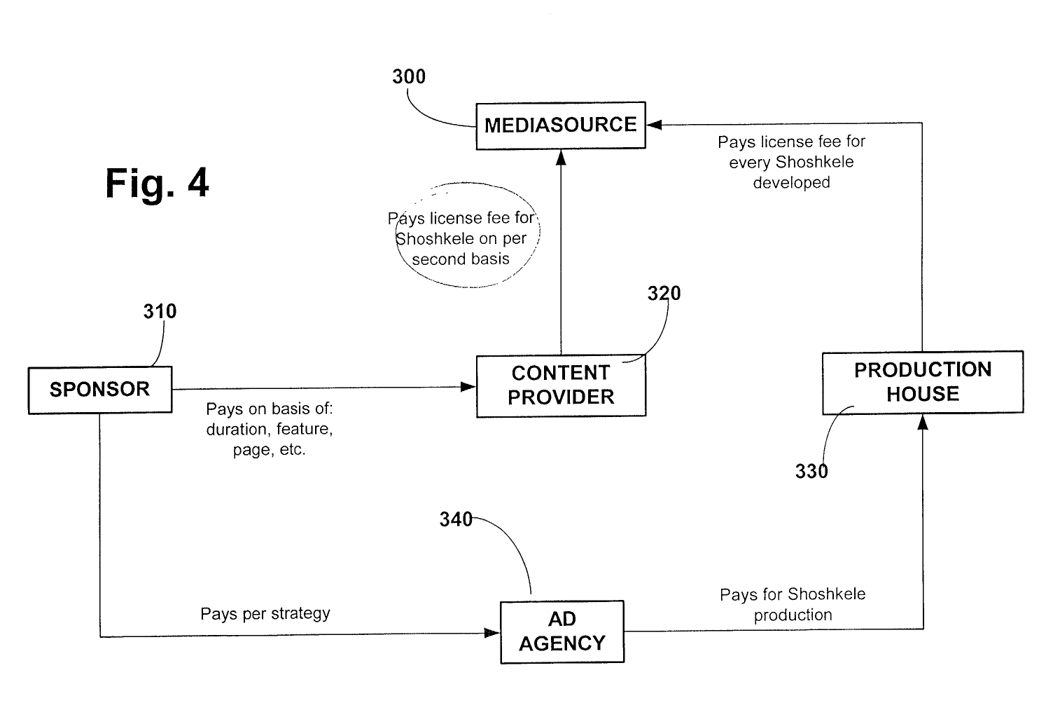

FIG. 4 is a block diagram illustrating a business method for Computerized advertising. It is assumed that the Shoshkeles would be made available through an organization 300 called MediaSource.

Marketing of the Shoskeles can be done through advertising agencies 340 which can offer them to their clients (e.g. sponsor 310) to produce commercials (‘shoshmercials’). Agency 340 is paid by Sponsor 310 on a project or “per strategy” basis. The agency 340 pays a production house 310 for the Shoshkele production. At a first stage, a Shoshkele could be ordered from MediaSource, with prepared scripts. At a later stage MediaSource shall offer a tool kit-‘the shoshkelizer’- that will allow the production house 330 or some other subcontractor to build a Shoshkele while paying a license fee to MediaSource. Once the Shoshmercial is produced, it would be provided to a user in any page where content provider 320 provided tags for insertion of a Shoshkele in content. Preferably, the advertiser would pay MediaSource and agreed fee for creating the Shoshkele, as well as a per impression fee (one impression=one exposure to one visitor), including a fee for the duration of an impression. MediaSource would deal with the content provider and pay its charges. Alternately, the content provider would pay MediaSource an amount to be decided, per Shoshkele, and then per impression. All the codes to activate the Shoshkele would stay in MediaSource's servers so anyone looking at the source of the page would not be able to copy the Shoshkele code.

An example: Budweiser's agency might revert to MediaSource for a five second Shoshkele of a dancing Magic Johnson. The agency might want to have exposure to the southwest American market through Yahoo or another portal (i.e. content provider 320). Agency 340 would furnish MediaSource with the animation in digital media (e.g. prepared by production house 330) complying to MediaSource's specifications. MediaSource would prepare the necessary coding transforming it to a Shoshkele, and the webmaster at Yahoo would insert tags Yahoo's page addressed t the Shoshkele server. MediaSource shall charge for this X dollars. The Shoshkele would be activated until certain codes are sent to it over the Internet. Once the Shoshkele is activated, on every Yahoo visit by a recognized southwestern visitor, every time the Shoshkele is played, MediaSource shall be paid Y cents. The agency will receive a percentage of MediaSource's revenue for every client it brings to MediaSource.

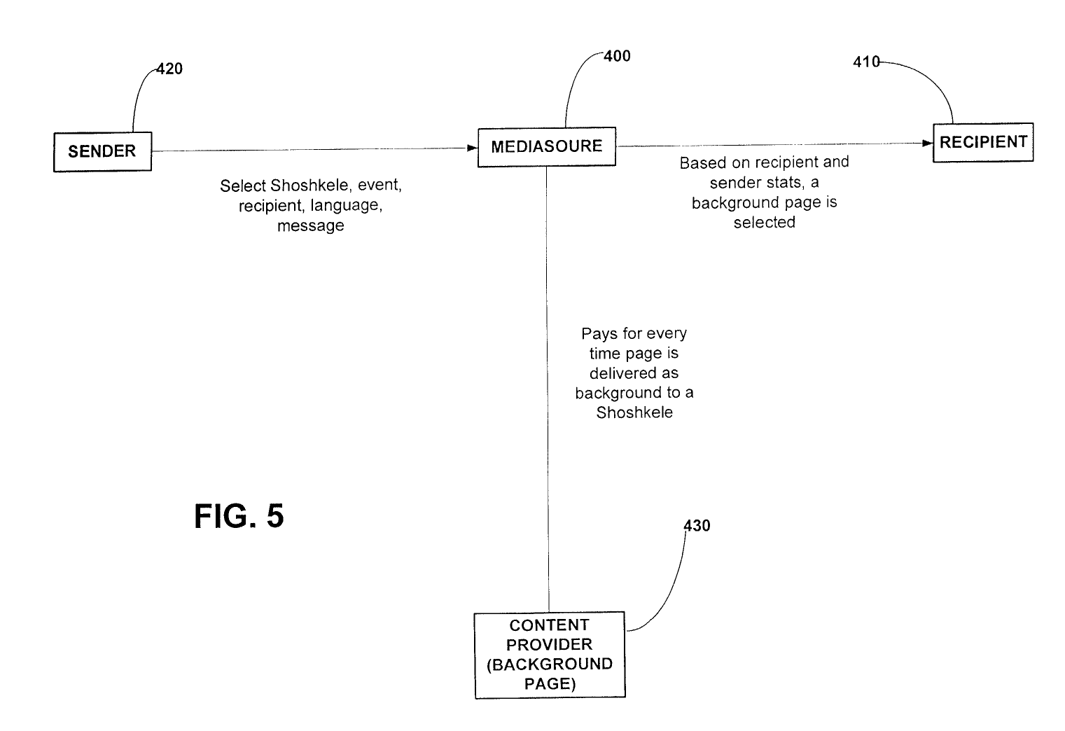

FIG. 5 is a block diagram illustrating a computerized greeting system utilizing Shoshkeles. Greeting cards are available now on the Internet but are never used in conjunction with background pages from paid advertisement. Building a greeting through a template with options in it, any Internet user will be able to send a greeting Shoshkele to another Internet user. This Shoshkele will appear on a background on a page in the Internet chosen by MediaSource, not by the visitor, so MediaSource can charge the site for doing so.

### EXAMPLE

An Internet visitor 420 comes to the greeting Shoshkele builder home page 400 (MediaSource), where he chooses from a gallery of characters (including his own picture). He then chooses actions and spoken, sung or written messages from a gallery of voices (including the user's own). He enters his own name and email address and identifies the person he wishes to send the greeting Shoshkele (name and email address). Then MediaSource's automated system sends an email to the recipient 410 pointing the recipient to a web page (in MediaSource's servers) where he can click and go to receive a greeting Shoshkele waiting for him. Arriving there, the recipient sees a regular and/or custom page prepared by an content provider or advertiser 430, for example Yahoo, and the greeting Shoshkele appears. MediaSource will have an agreement based on number of impressions, to be paid by the content provider. MediaSource will be charging an additional amount the longer the visitor stays in the background site. Please note that the template could be used to make Shoshkeles for the general public, to do advertisement or other things to run on their web sites or others.

### Guiding And/or Teaching Shoshkeles

Shoshkeles could appear at Internet sites to guide the user toward features and/or areas and/or other pages, as well as to help in teaching a language, a trade, sex techniques, a dance, martial arts, censorship, reading the news, etc. It may point to mistakes in the use of a computer.

### Updating Software

A Shoshkele appears on the screen offering to update software that has been outdated, or a plug-in that is missing, or replacing an old one.

### Reduced Cost Software (Containing Advertising)

A Shoshkele is activated with software downloaded from the Internet or provided on media that will reduce the cost of such software.

Examples:

A user downloads an antivirus program and the free version, when executed, opens a browser window and a Shoshkele plays. This may happen every time the antivirus program is updated and/or only once.

An Internet surfer wants to know if a certain person has filed for chapter eleven protection, and a commercial site offering this information allows the downloading of the data or will send it in a diskette or CD ROM, which will be free, while making a profit by attaching to it a Shoshkele.

International calls are made through the Internet using a microphone and speakers through a dial pad, dialing any place in the world, but the conversation is interlaced at both ends with a Shoshkele (may be only sound).

Shoshkeles are to the Internet what commercials are to television, meaning that until now all the advertisement done on the Internet was done through banners (similar to ads in magazines or newspapers). On the other hand the Shoshkeles since they talk and are human-like, if desired, resemble television commercials.

### Special Qualities of Shoshkeles Compared to Banners

1. They are not scrollable. That means that if, for example, the Shoshkele walks in and says ‘Have a coke’ and the user does not want to see it, the Shoshkele cannot be scrolled out, as can a banner. It will stay on the screen until finished.

2. Sound. The only two methods used today on the Internet for advertisement, if at all, are:

MIDI music, which is computer generated sound or

to utilize a special program that must be downloaded (plug-ins or other ) to be able to hear that sound. Example: Flash, You don't know Jack. Shoshkeles, on the other hand, will play any sound, mono, stereo, music, or talk, on any of the two main browsers (Netscape and Explorer), in their versions 4.0 and above (97.5% of the users today).

3. As opposed to banners, regular users cannot notice in advance that a Shoshkele may appear. When a page is opened, until it is fully downloaded, the place of the banner is earmarked, while a Shoshkele downloads silently and unobtrusively.

4. Transparency. Banners are not transparent, Shoshkeles are not either, but the area immediately around the Shoshkele is, and when the Shoshkele moves around, every place it moves away from stays fully viewable (transparent). This is different from pop-up windows, which are not. The Shoshkele does not have a special window around it. You cannot minimize it or close it. It is in the outer layer of the page.

5. Shoshkeles are fully customizable.

Examples:

It could be a celebrity made out of full digital video and sized to fit any requirement. For example, Ricky Martin, Magic Johnson, etc. He could talk (“Have a Pepsi’) or simply have a Pepsi in his hands without saying anything. He could sing and talk or have any sound effect, like steps, door closing, etc., even in stereo, (walking from one speaker to the other).

It could be an animated character. A celebrity such as Bugs Bunny, any cartoon, or cartoon-like person, with all the sound effects, as above.

It could be a shark fin, navigating the written page, with ‘Jaws’ music in the background, finally emerging as the Nike swoosh symbol.

It could be dancing letters from the page the person is viewing with or without sound.

It could be just sound (“Have a Coke’)

6. Fully synchronizable. The meaning of this, is that a Shoshkele can be preset to appear once or several times and/or in any time spacing chosen. For example: Ricky Martin can come and say “Have a Pepsi’ and never appear again, or reappear every three minutes, and/or the shark fin (see above) can appear twenty seconds after Ricky Martin has gone. It could last from one second to any length of time chosen. If the page on which the Shoshkeles appears is minimized, the figure of the Shoshkele disappears with the page. If the page is closed both the figure and the voice will disappear.

7. Ease of implementation. It takes less than five minutes for any webmaster to activate or deactivate a Shoshkele routine.

8. Interaction with cookies. The Shoshkele will interact with cookie technology so:

It may personalize a message (‘Have a Pepsi, Mister Smith’) or (‘Tome usted una Pepsi, Se?or Smith’-Spanish-)

It may recognize that this person has been exposed to this and/or another Shoshkele before and when so it might ask ‘Were you scared of the shark?’. It may be used to tell a story in chapters, without appearing too often to become annoying.

It permits the introduction of cookies.

Although a preferred embodiment of the invention has been disclosed for illustrative purposes, those skilled in the art will appreciate that many additions, modifications and substitutions are possible, without departing from the scope and spirit of the present invention as defined by the accompanying claims.

What is claimed is:

1. A method for modifying an image produced by an application program on the display screen of a computer system, the computer system running the application program under an operating system having a graphical user interface, the method comprising the steps of introducing into the screen a multimedia animated character, said character being a changing image which appears on the screen intrusively in a manner which is unpredictable for the computer user and which is completely beyond the user's control.

2. The method according to claim 1, wherein said character moves translationally on the computer screen.

3. The method according to claim 2 utilized in an operating system which produces multilayer window images on the screen, said character being located in the uppermost layer of the application program window, so that a user cannot move it off the screen or cover it with other objects.

4. The method according to claim 3, wherein said character is accompanied by synchronized sound.

5. The method according to claim 4, wherein the character overlies an existing image produced on the screen by the application program, a portion of the character being transparent, so that a portion of the existing image can be seen therethrough.

6. The method according to claim 5, wherein the generation of said character is controlled with signals stored in a database in response to an exchange of information from the user's computer.

7. A method according to claim 6, wherein said signals stored in the database define a plurality of said characters which are selected and controlled according to information from the user's computer which is not under the user's control and technical features available in the user's computer.

8. The method of claim 7, wherein the user's computer is connected to a network, to which there is also connected a character controlling server, in communication with the user's computer, the server having access to the database, said method further comprising the steps of producing a series of instructions executed in the server through an interactive process between the user's computer and the server, to determine a sequence of commands that selects control signals corresponding to one of the characters from said database, and sending the commands to the user's computer for use in introducing the character into the application program image.

9. The method of claim 8, wherein the application program is a browser and the commands are provided to the user's computer within an HTML page being viewed by the user.

10. The method of claim 9 wherein the HTML page being viewed by the user was received from a content provider's server and the character is introduced therein as a result of tags left in the page by the content provider.

11. The method of claim 1, wherein the executable code for the character is incorporated in one of installation media and an installation file for the application program, and the executable code is installed at the same time as the application program.

12. A method for introducing advertising material into multimedia content being viewed by a user over a computer network in which the user's computer is a client running an application program under an operating system having a graphical user interface, the content being received from a content provider's computer acting as a content server, there also being connected to the network a computer operated by a media source acting as a character controlling server, the method comprising the steps of:
sending content from the content server to the client and providing in the content a tag communicating to the character controlling server; and
at the character controlling server, upon being contacted by the client, transferring to the client control signals that will produce on the clients computer display of the content a multimedia animated character, said character being a changing image which appears on the content intrusively in a manner which is unpredictable for the computer user and which is completely beyond the his control.

13. The method of claim 12 wherein the media source receives payment based upon the number of accesses to a character and the duration of an access.

14. The method according to claim 12, wherein said character moves translationally on the computer screen.

15. The method according to claim 14 utilized in an operating system which produces multilayer window images on the screen, said character being located in the uppermost layer of the application program window, so that a user cannot move it off the screen or cover it with other objects.

16. The method according to claim 15, wherein said character is accompanied by synchronized sound.

17. The method according to claim 16, wherein the character overlies an existing image produced on the screen by the application program, a portion of the character being transparent, so that a portion of the existing image can be seen therethrough.

18. The method according to claim 17, wherein said control signals are generated on the basis of information stored in a database in response to an exchange of information from the user's computer.

19. The method according to claim 18, wherein said signals stored in the database define a plurality of said characters which are selected and controlled according to information from the user's computer which is not under the user's control and technical features available in the user's computer.

20. The method according to claim 19 wherein the information from the user's computer is derived from a cookie stored within the computer.

21. A method for providing an electronic greeting from a sender to a recipient over a computer network in which the computers of both are clients running an application program under an operating system having a graphical user interface, the greeting being produced by a media source's computer acting as a media server acting as a character controlling server, there also being connected to the network a computer operated by a content provider, the method comprising the steps of:
at the senders computer selecting characteristics of the greeting, including a character to present the greeting, the recipient and the message to be sent;
at the character controlling server, upon being contacted by the sender, sending to the recipient control signals that will produce on the recipients computer display a multimedia animated character delivering the message, said character being a changing image which appears on the content intrusively in a manner which is unpredictable for the recipient and which is completely beyond the his control, the server also providing a signal to the recipient which will call a page provided by the content provider as background to the character and remains after the message is delivered.

22. The method of claim 21 wherein the media source receives payment from the content provider based upon the number of times the content provider's page is delivered as background to a greeting.

23. A system for modifying an image produced by an application program on the display screen of a computer, the computer running the application program under an operating system having a graphical user interface, comprising:
a generator of media signals which are configured to produce on the user's display of the application program a multimedia animated character, said character being a changing image which appears on the screen intrusively in a manner which is unpredictable for the computer user and which is completely beyond the user's control; and
means for introducing the character to the user's computer display.

24. The system of claim 23, wherein said media signals are configured to produces a character that moves translationally on the computer screen.

25. The system of any one of claims 23 or 24 wherein operating system produces multilayered window images on the screen, said said media signals being configured to located the character in the uppermost layer of the application program window, so that a user cannot move it off the screen or cover it with other objects.

26. The system according to claim 25, wherein said media signal is configured so that the character is accompanied by synchronized sound.

27. The system according to claim 26, wherein the media signal is configured so that the character overlies an existing image produced on the screen by the application program and a portion of the character is transparent, so that a portion of the existing image can be seen therethrough.

28. The system according to claim 27, wherein the media signal is generated based upon information stored in a database in response to an exchange of information from the user's computer.

29. A system according to claim 28, wherein the information stored in the database defines a plurality of characters, the system further comprising a selector responsive to information from the user's computer which is not under the user's control and technical features available in the user's computer to select media signals corresponding to one of the characters.

30. The system of claim 29, further comprising a connection between the user's computer and a network, a character controlling server also connected to the network in communication with the user's computer, the server having access to the database, said media signal generator being controlled through interactive communication between the user's computer and the server.

31. The system of claim 30, wherein the application program is a browser and the media signals are provided to the user's computer along with an HTML page being processed by the user's computer.

32. The system of claim 31 further comprising content provider's server connected to the network for communication with the user's computer the HTML page being viewed being received from content provider's server, the character being introduced as a result of tags left in the page by the content provider.

33. The system of claim 1, wherein the generator comprises a computer program that is installed on the user's computer at the same time as the application program from one of installation media and an installation file for the application program.

34. The method according to claim 1 utilized in an operating system which produces multilayer window images on the screen, said character being located in the uppermost layer of the application program window, so that a user cannot move it off the screen or cover it with other objects.

35. The method according to claim 1, wherein said character is accompanied by synchronized sound.

36. The method according to claim 1, wherein the character overlies an existing image produced on the screen by the application program, a portion of the character being transparent, so that a portion of the existing image can be seen therethrough.

37. The method according to claim 1, wherein the generation of said character is controlled with signals stored in a database in response to an exchange of information from the user's computer.

38. A method according to claim 37, wherein said signals stored in the database define a plurality of said characters which are selected and controlled according to information from the user's computer which is not under the user's control and technical features available in the user's computer.

39. The method of claim 1, wherein the user's computer is connected to a network, to which there is also connected a character controlling server, in communication with the user's computer, the server having access to the database, said method further comprising the steps of producing a series of instructions executed in the server through an interactive process between the user's computer and the server, to determine a sequence of commands that selects control signals corresponding to one of the characters from said database, and sending the commands to the user's computer for use in introducing the character into the application program image.

40. The method of claim 1, wherein the application program is a browser and the commands are provided to the user's computer within an HTML page being viewed by the user.

41. The method of claim 40 wherein the HTML page being viewed by the user was received from a content provider's server and the character is introduced therein as a result of tags left in the page by the content provider.

42. The method according to claim 12 utilized in an operating system which produces multilayer window images on the screen, said character being located in the uppermost layer of the application program window, so that a user cannot move it off the screen or cover it with other objects.

43. The method according to claim 12, wherein said character is accompanied by synchronized sound.

44. The method according to claim 12, wherein the character overlies an existing image produced on the screen by the application program, a portion of the character being transparent, so that a portion of the existing image can be seen therethrough.

45. The method according to claim 12, wherein said control signals are generated on the basis of information stored in a database in response to an exchange of information from the user's computer.

46. The method according to claim 1, wherein said signals stored in the database define a plurality of said characters which are selected and controlled according to information from the user's computer which is not under the user's control and technical features available in the user's computer.

47. The method according to claim 46 wherein the information from the user's computer is derived from a cookie stored within the computer.

48. The system according to claim 23, wherein said media signal is configured so that the character is accompanied by synchronized sound.

49. The system according to claim 23, wherein the media signal is configured so that the character overlies an existing image produced on the screen by the application program and a portion of the character is transparent, so that a portion of the existing image can be seen therethrough.

50. The system according to claim 23, wherein the media signal is generated based upon information stored in a database in response to an exchange of information from the user's computer.

51. A system according to claim 50, wherein the information stored in the database defines a plurality of characters, the system further comprising a selector responsive to information from the user's computer which is not under the user's control and technical features available in the user's computer to select media signals corresponding to one of the characters.

52. The system of claim 50, further comprising a connection between the user's computer and a network, a character controlling server also connected to the network in communication with the user's computer, the server having access to the database, said media signal generator being controlled through interactive communication between the user's computer and the server.

53. The method according to claim 52 utilized in an operating system which produces multilayer window images on the screen, said character being located in the uppermost layer of the application program window, so that a user cannot move it off the screen or cover it with other objects.

54. The method according to claim 53, wherein said character is accompanied by synchronized sound.

55. The method of claim 6, wherein the user's computer is connected to a network, to which there is also connected a character controlling server, in communication with the user's computer, the server having access to the database, said method further comprising the steps of producing a series of instructions executed in the server through an interactive process between the user's computer and the server, to determine a sequence of commands that selects control signals corresponding to one of the characters from said database, and sending the commands to the user's computer for use in introducing the character into the application program image.

56. The method of claim 55 wherein the HTML page being viewed by the user was received from a content provider's server and the character is introduced therein as a result of tags left in the page by the content provider.

57. The method of claim 56, wherein the executable code for the character is incorporated in one of installation media and an installation file for the application program, and the executable code is installed at the same time as the application program.
